(19) United States
(12) Patent Application Publication
(10) Pub. No.: US 2025/0069825 A1
(43) Pub. Date: Feb. 27, 2025

(54) DOOR LOCK INTERCONNECT SYSTEM FOR AN ELECTRICAL ENCLOSURE

(71) Applicant: Rittal GmbH & Co. KG, Herborn (DE)

(72) Inventors: Dwayne PLOTT, Springfield, OH (US); Daniel LARIMORE, Marysville, OH (US)

(21) Appl. No.: 18/708,533

(22) PCT Filed: Nov. 8, 2022
(86) PCT No.: PCT/US2022/049327

§ 371 Date: May 8, 2024

Related U.S. Application Data
(60) Provisional application No. 63/277,157, filed on Nov. 8, 2021.

(51) Int. Cl. H01H 9/22; E05C 3/08

(52) U.S. Cl. CPC H01H 9/22; E05C 3/08

(57) ABSTRACT

A door lock interconnect system for interfacing with a disconnect for an electrical enclosure. The door lock interconnect system includes an interconnect assembly having a door lock lever adapted for pivotal movement about an axis, and a disconnect engagement lever adapted for pivotal movement about the axis, the disconnect engagement lever further adapted to engage with the door interlock link of the disconnect such that movement of the door interlock link causes pivotal movement of the disconnect engagement lever. The system further includes a door catch engageable by the door lock lever of the interconnect assembly and an adjustable mounting assembly for the door catch.

### CROSS REFERENCE TO RELATED APPLICATIONS

This application claims priority to U.S. Provisional Patent Application No. 63/277,157, filed on Nov. 8, 2021. The entire disclosure of the foregoing provisional patent application is incorporated by reference herein.

### BACKGROUND

The present disclosure relates to a disconnect module and door lock interconnect system for an electrical enclosure, particularly for a compact electrical enclosure such as those used as hygienic design enclosures.

Disconnect handles and linkages are used to increase the operating safety of electrical enclosures. In order to avoid an electrical shock to a user, these components (also referred to as disconnects) are configured such that the control box access door may only be opened when power to the box has been disconnected. Typically, a flange mount disconnect (“FMD”) is integrated into the control box and is used to control disconnect switches as well as circuit breakers or other devices within the control box, and to prevent the access door of the control box from being opened while power is being supplied to the control box.

Further, equipment used in certain industries and facilities often must meet stringent hygienic standards in order to provide sufficient sterility as well as allow for frequent cleaning, particularly cleaning that involves the use of water or other cleaning solvents. For example, these requirements are applicable to equipment used in the bioprocessing, pharmaceutical and personal care products industries, such as processes in which a product is made from raw materials by the application of chemical, physical or biological procedures. For example, food-processing facilities, particularly those involving protein products (i.e. meat, poultry, fish, seafood and dairy) are subject to strict hygiene requirements and must be washed down daily using hot, high-pressure water and chemical agents. Equipment used in these industries typically must meet “hygienic design” (or “HD”) standards, such as those established by ASME (particularly, the Bioprocessing Equipment or “BPE” standards of the ASME), 3-A Sanitary Standards Incorporation (“3-A Standards”), or the European Hygienic Design Group (“EHEDG”). The foregoing are collectively referred to herein as “HD Standards.”

These HD Standards generally require that the interior and exterior of equipment be self-draining, with no horizontal surfaces (e.g., at least a 3% slope) when the equipment is installed in its intended orientation. The equipment should also be impervious to water and other cleaning solutions, including having a NEMA rating of at least 4 or 4X (or an IP rating of at least IP66).

### BRIEF DESCRIPTION OF THE DRAWINGS

While the specification concludes with claims particularly pointing out and distinctly claiming the invention, it is believed that the invention will be better understood from the detailed description of certain embodiments thereof when read in conjunction with the accompanying drawings. Unless the context indicates otherwise, like numerals are used in the drawings to identify similar elements in the drawings. In addition, some of the figures may have been simplified by the omission of certain elements in order to more clearly show other elements. Such omissions are not necessarily indicative of the presence or absence of particular elements in any of the exemplary embodiments, except as may be explicitly stated in the corresponding detailed description.

FIG. 1 depicts an isometric view of an electrical enclosure (e.g., a control box) with a FMD-carrying sidecar of the present disclosure attached to the enclosure.

FIG. 2 depicts an exploded view of the sidecar and electrical enclosure of FIG. 1, wherein the access door has been omitted along with the interconnect assembly and other components typically found within the enclosure.

FIG. 3 depicts a side view of the enclosure of FIG. 1, showing the modifications made for operative attachment of the sidecar and the interconnect system of the present disclosure.

FIG. 4 is an exploded, isometric view of the sidecar of FIG. 1, with the FMD and interconnect assembly omitted.

FIG. 5 is an assembled, isometric view of the sidecar of FIG. 4.

FIG. 6 is an isometric view of the sidecar and electrical enclosure of FIG. 2, taken from the interior of the enclosure and depicting the attachment of the sidecar to the enclosure, with the access door, FMD, interconnect assembly, and other components typically found within the enclosure omitted.

FIG. 7 is a view similar to FIG. 6, but taken from the upper interior of the sidecar.

FIG. 8 is an isometric view of an exemplary FMD.

FIG. 9 depicts the FMD of FIG. 8 mounted to and within the sidecar of FIG. 4, with the fastening components for the FMD omitted.

FIGS. 10A and 10B are rear and front isometric views of an interconnect assembly according to the present disclosure.

FIG. 11 is an exploded view of the interconnect assembly of FIGS. 10A and 10B.

FIG. 12 is an isometric view of the FMD of FIG. 8 and the interconnect assembly of FIGS. 10A-11, depicting the interconnect pin engaged in the slot of the disconnect (or FMD) engagement lever of the interconnect assembly.

FIG. 13 is a cross-sectional view of the interconnect assembly of FIG. 10B.

FIG. 14 is a rear cross-sectional view of an assembled electrical enclosure, attached sidecar, FMD, interconnect assembly and adjustable mounting assembly of the present disclosure, wherein other components typically found within the enclosure omitted.

FIG. 15 is a view similar to FIG. 14, with the cabinet and sidecar omitted.

FIG. 16 is a side view of the assembly shown in FIG. 15.

FIG. 16A is an enlarged view of a portion of FIG. 16.

FIG. 17 is a side view of an embodiment of an adjustable mounting assembly of the present disclosure, wherein fasteners for securing the various components to one another have been omitted.

FIG. 18 is an isometric view of the adjustable mounting assembly of FIG. 17.

FIGS. 19A and 19B are exploded views of the adjustable mounting assembly of FIG. 17.

FIG. 19C is a view of the adjustable mounting assembly of FIG. 17, partially assembled.

FIG. 20 is an enlarged view of a portion of an access door depicting the mounting of the adjustable mounting assembly of FIG. 17 to the access door.

FIG. 20A is an exploded view of FIG. 20.

FIG. 21 is an enlarged view of a portion of an assembled electrical enclosure, access door, attached sidecar, FMD, interconnect assembly and adjustable mounting assembly of the present disclosure, wherein a portion of the FMD is shown in cross-section and other components typically found within the enclosure have been omitted.

FIG. 22 is an enlarged side view of the assembly of FIG. 21.

The drawings are intended to illustrate rather than limit the scope of the present invention. Embodiments of the present invention may be carried out in ways not necessarily depicted in the drawings. Thus, the drawings are intended to merely aid in the explanation of the invention. Thus, the present invention is not limited to the precise arrangements shown in the drawings.

### DETAILED DESCRIPTION

The following detailed description describes examples of embodiments of the invention solely for the purpose of enabling one of ordinary skill in the relevant art to make and use the invention. As such, the detailed description and illustration of these embodiments are purely illustrative in nature and are in no way intended to limit the scope of the invention, or its protection, in any manner. It should also be understood that the drawings are not to scale and in certain instances details have been omitted, which are not necessary for an understanding of the present invention.

Embodiments of the present disclosure provide a disconnect module, as well as a door lock interconnect system for an electrical enclosure (e.g., a control box), particularly for a hygienic design enclosure. The present disclosure also provides an easily retrofitable sidecar enclosure for mounting to an existing enclosure, wherein a disconnect is mounted to the sidecar and can be operatively connected to both the circuit breakers within the enclosure as well as the access door. The modular design of the sidecar allows for power to be controlled locally at the enclosure, while, if desired, still meeting hygienic design standards (e.g., a Nema/UL 4X rating). The modular design also allows for the disconnect and associated disconnect linkage to be external to the usable space of the enclosure (i.e., inside the sidecar), with an adjustable interconnect assembly for interconnecting the disconnect linkage (e.g., a door interlock link) to the enclosure and its access door. The design is easily retrofitable to existing enclosures, and the sidecar is compact, saving physical space around the outside of the enclosure it is mounted to. The system can also be used on a wide variety of Nema/UL 4/4X enclosures. Also, while the system of the present disclosure can be configured for use with HD enclosures, its applicability is not limited to HD enclosures alone. Embodiments of the system are also highly flexible in that, for example, the sidecar can be mounted to either side of an enclosure.

In one embodiment, a door lock interconnect system for interfacing with a disconnect (e.g., an FMD) for an electrical enclosure is provided. The disconnect has an operating lever (e.g., 66) with a door interlock link (64) operatively connected to the operating lever. The operating lever is pivotable between on and off positions and is operative to disconnect and connect power to the enclosure (e.g., by controlling circuit breakers). The door lock interconnect system includes:
an interconnect assembly (70) having a door lock lever a adapted for pivotal movement about an axis, and
a disconnect engagement lever (74) adapted for pivotal movement about the axis.

The disconnect engagement lever is further adapted to engage with the door interlock link of the disconnect such that movement (e.g., substantially linear or translational movement) of the door interlock link causes pivotal movement of the disconnect engagement lever. The door lock lever and the disconnect engagement lever are operatively connected such that the pivoting of one of the door lock lever and the disconnect engagement lever about the axis results in pivoting of the other of the door lock lever and the disconnect engagement lever about the axis;

The door lock interconnect system further includes a door catch (90) engageable by the door lock lever of the interconnect assembly, and an adjustable mounting assembly (100). The door catch is attachable to the adjustable mounting assembly, and the adjustable mounting assembly is adapted to be secured to an interior face of the access door. The door catch and the adjustable mounting assembly are adapted to adjustably locate the door catch with respect to the interior face of the access door.

The interconnect assembly is configured to be operatively mounted to the electrical enclosure between the disconnect and the access door such that the interconnect assembly operatively links the door interlock link of the disconnect and the door catch whereby the operating lever cannot be pivoted to its on position if the access door is open, and the access door cannot be opened if the operating lever is at its on position.

In some embodiments, the door lock lever further comprises a door lock catch pin, and the door catch further comprises a door catch slot for slidably receiving the door lock catch pin of the door lock lever. Also, the interconnect assembly can further comprises a rotational member (e.g., pivot pin (88)) located on the axis mentioned previously, the rotational member extending between and operatively connecting the door lock lever and the disconnect engagement lever such that pivoting of the disconnect engagement lever about the axis of the rotational member causes pivoting of the door lock lever about the axis of the rotational member.

In some embodiments, the interconnect assembly further includes an interconnect pin (72) and the disconnect engagement lever includes a slot (76) for slidably receiving the interconnect pin, wherein the interconnect pin is adapted to be connected to the door interlock link of the disconnect (e.g., such that substantially linear movement of the door interlock link is translated into pivotal movement of the disconnect engagement lever. The disconnect engagement lever can further include an elongate lever arm (75), wherein the slot in the engagement lever extends from a distal open end of the lever arm along at least a portion of a length of the elongate lever arm. The elongate lever arm extends radially away from the rotational member.

In some embodiments, the interconnect assembly further comprises an interconnect bracket (80) adapted for attachment to the electrical enclosure. The interconnect bracket comprises a mounting plate (81). The door lock lever is positioned adjacent a first side of the mounting plate and the disconnect engagement lever is positioned adjacent a second side of the mounting plate such that the mounting plate is located between the door lock lever and the disconnect engagement lever. In still further embodiments, the interconnect assembly further comprises a fixed member (e.g., barrel (84) extending laterally away from at least one of the first and second sides of the mounting plate. The fixed member includes an aperture (85) extending thererethrough, wherein the rotational member is rotatably positioned within the fixed member. In some embodiments, the rotational member is a pivot pin (88) having first and second ends, wherein the door lock lever and the disconnect engagement lever are secured to opposite ends of the pivot pin.

In further embodiments, wherein the interconnect bracket is adapted to be secured to the electrical enclosure adjacent to an opening in a sidewall of the electrical enclosure such that the door lock lever is located within the electrical enclosure and the engagement lever is located external to the electrical enclosure adjacent the sidewall opening. The interconnect bracket can be adapted to be adjustably and alignably secured to the electrical enclosure, such that the securement height of the interconnect bracket can be adjusted to ensure that the door lock catch pin is received within the slot of the door catch.

In some embodiments, the door catch slot extends between an open lower end, a sloped forward wall (94) extending upwardly from the open lower end to a closed upper end (93) of the slot, and a rear wall (95) extending downwardly from the closed upper end and spaced away from the sloped forward wall, and further wherein the door catch and adjustable mounting assembly are securable to the interior face of the access door such that the door catch slot extends at an angle with respect to the interior face of the access door.

In some embodiments, the adjustable mounting assembly (100) is telescopically adjustable in length such that the position of the door catch with respect to the access door is adjustable by telescoping adjustment of the adjustable mounting assembly. For example, the adjustable mounting assembly of some embodiments comprises a first fixation member (102, 104) adapted to be secured to the interior face of the access door, a slide plate (110) adapted to be adjustably secured to the first fixation member and to be secured to the door catch, such that the position of the door catch with respect to the access door is adjustable by adjustment of the securement of the slide plate to the fixation member. The first fixation member can comprise a first channel member (102, 104), wherein the slide plate is slidingly received within the first channel member for adjustably securing the slide plate to the channel member, with the door catch adjustably securable to the slide plate. The adjustable mounting assembly of some embodiments further comprises at least one slide lock (120) for securing the slide plate within the first channel member. In still further embodiments, the adjustable mounting assembly includes a second channel member (104) adapted to be secured to the interior face of the access door in vertical alignment with the first channel member (102), wherein the slide plate (110) is slidingly received within both the first and second channel members. In this embodiment, the adjustable mounting assembly can include of a pair of slide locks, with each slide lock configured to secure the slide plate in one of said channel members. The adjustable mounting assembly can further include a door catch mounting bracket (130) for securing the door catch to the slide plate. The door catch can be adjustably secured to the door catch mounting bracket, and the door catch mounting bracket can be adjustably securable to the slide plate.

The door lock interconnect system can further include an adapter box (also referred to as a sidecar box (40) configured to be attached to a sidewall of the electrical enclosure, and a disconnect (e.g., an FMD (60)) mounted to the adapter box such that the operating lever of the disconnect is located external to the adapter box and the door interlock link is located within the adapter box. The adapter box can be configured to be sealingly attached to the sidewall of the electrical enclosure, particularly in order to provide a hygienic design arrangement.

Embodiments of the present disclosure further provide a disconnect module for attachment to an electrical enclosure having a cabinet and an access door, the disconnect module comprising:
an adapter box adapted to be attached to a sidewall of the electrical enclosure adjacent the access door;
a flange mount disconnect (FMD) mounted to the adapter box, the FMD having an operating lever and a door interlock link operatively connected to the operating lever, the operating lever pivotable between on and off positions and operative to control circuit breakers supplying power to the electrical enclosure; and
a door lock interconnect system such as described above and herein.

One embodiment of a door lock interconnect system of the present disclosure comprises an interconnect pin mountable to a portion of an FMD, a slotted lever having an elongate slot for slidably receiving a portion of the interconnect pin therein, an interconnect bracket, and a door lock lever. The door lock lever and slotted lever are configure to be rotatably secured with respect to the mounting bracket such that rotational movement of the door lock lever causes rotational movement of the slotted lever and substantially linear movement of the interconnect pin within the elongate slot of the slotted lever.

Embodiments of the present disclosure also provide a method of retrofitting a sidecar, FMD, and door lock interconnect system to an electrical enclosure. Embodiments of the present disclosure further provide an adjustable mounting assembly for adjustably attaching a door catch to an interior face of an access door for an electrical enclosure.

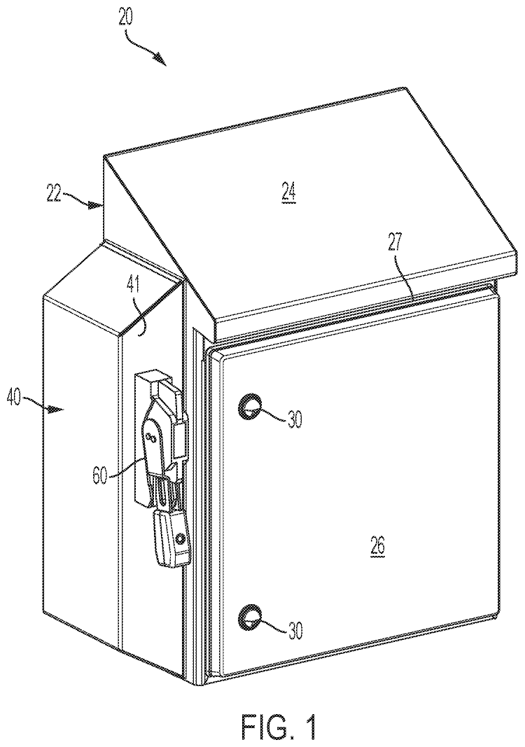

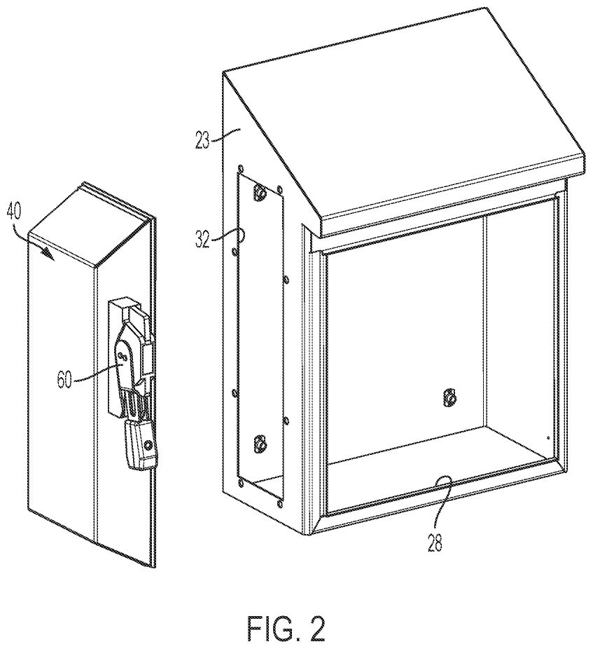

FIG. 1 depicts an isometric view of an HD electrical enclosure (20) suitable for use in housing various electrical components. In some instances, such enclosures are known as “control boxes.” The term “HD” enclosure means that the enclosure (20) and other components described herein meet the applicable HD Standards (including, e.g., NEMA 4 or 4X). The enclosure (20) includes a cabinet (22) having a sloped roof (24) and a lockable access door (26) hingedly mounted to the front of the cabinet over an opening (28) in the front of the cabinet (see FIG. 2). A seal (27) is also provided between the access door (26) and the cabinet (22), and extends around the periphery of the opening (28) so that it provides a seal between the access door and the cabinet. A pair of locks (30) are also provided such that the door (26) can be locked in the closed position shown in FIG. 1.

As best seen in FIG. 1 and the exploded view of FIG. 2, an adapter box (40), referred to herein as a sidecar, is mounted to a sidewall (23) of the cabinet (22), over a rectangular opening (32) formed in the sidewall (23) of the cabinet. It will be understood that the access door (26) along with other components of the system are omitted in FIG. 2 for clarity. A flange mount disconnect (“FMD”) (60) is operatively mounted to a front face of the sidecar (40). As is well known in the art, an FMD is used to control circuit breakers supplying power to an electrical enclosure and the prevent the access door from being opened while power is being supplied to the enclosure. Moving the operating lever (66) of the FMD (60) to the off position shown in FIGS. 1 and 2 trips the circuit breaker (not shown) within the cabinet, thereby cutting off the supply of power to the enclosure. The FMD (60) also prevents the access door from being opened unless and until the operating lever (66) is in the off position shown in FIG. 2, thereby preventing access to the interior of the cabinet while power is being supplied thereto. It will be understood that any of a variety of FMDs may be used with the system of the present disclosure besides the type shown.

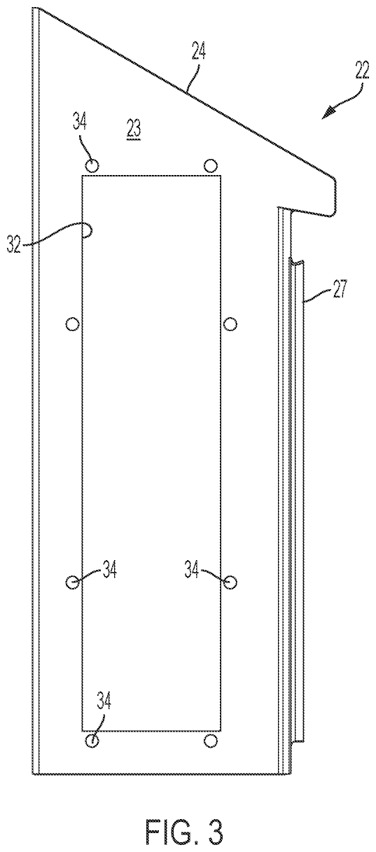

The sidecar (40) and other components of the system described herein can be retrofit to an existing cabinet (22). In particular, and with reference to the side view of FIG. 3, an opening (32) can be cut into the sidewall (23) of an existing cabinet (22), along with a plurality of mounting apertures (34) arrayed about the opening (32). In the example shown, eight mounting apertures (34) are provided, with a pair located adjacent and above the upper edge of the opening, a pair located adjacent and below the lower edge of the opening, and two pair located adjacent each of the right and left edges of the opening (32). Of course, this arrangement is only exemplary as other arrangements and numbers of apertures may be used. The mounting apertures are used to mount the sidecar (40) to the sidewall (23) of the cabinet, as explained below.

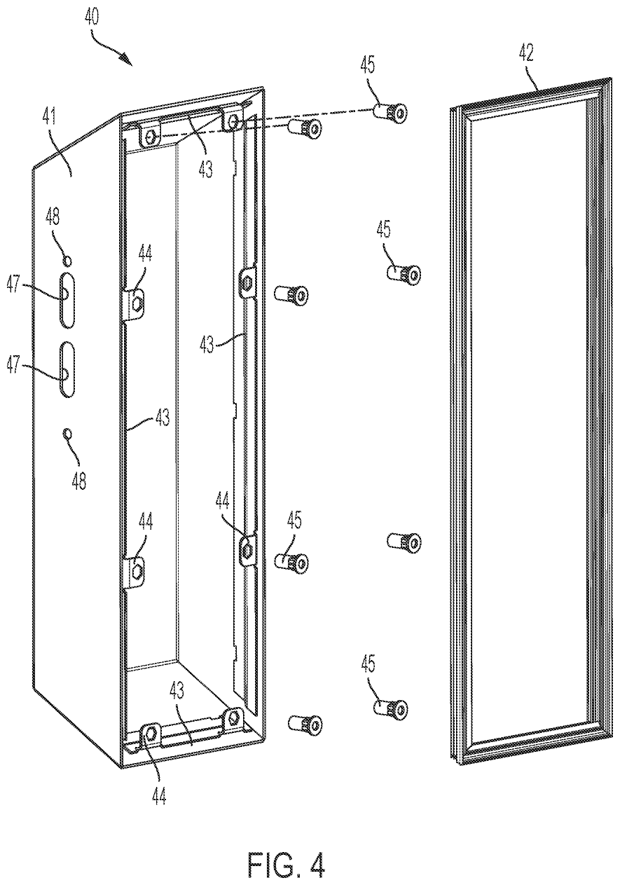

FIG. 4 is an exploded view of the sidecar (40), with the FMD and related components omitted for clarity. Sidecar (40) includes a sidecar cabinet having s sloped roof and bottom, along with a sidecar seal (42). Four flanges (43) are welded to the interior of the of the sidecar cabinet, each flange having a pair of apertured tabs (44). The number and arrangement of the apertured tabs (44) correspond to the number and arrangement of the mounting apertures (34) in the sidewall of the cabinet (22).

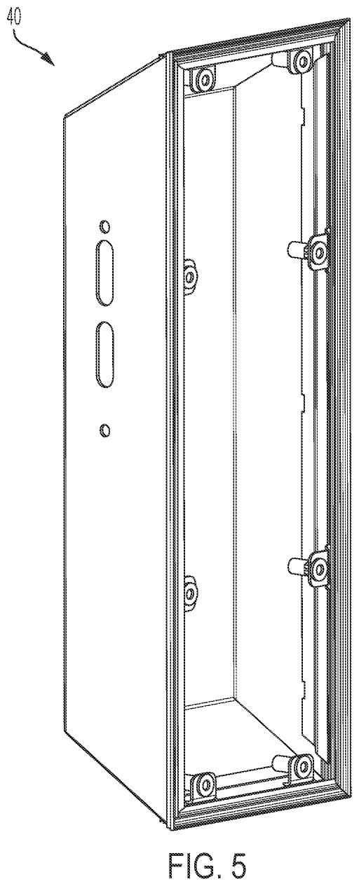

A plurality of internally threaded mounting bolts (45) (also known as rivet nuts or threaded inserts) are secured within (e.g., welded) the apertured tabs (44) as seen in the assembled sidecar shown in FIG. 5. A pair of elongate passageways (47) are provided in the front wall (41) of the sidecar cabinet for receiving the actuator link and the door interlock link (described below) of the FMD. Two or more apertures (48) are also provided in the front wall (41) for mounting the FMD (60) to the sidecar using, for example, threaded fasteners (e.g., mounting screws or bolts and lock washers or nuts, not shown). A seal (not shown) is also provided in order to sealingly secure the FMD (60) to the sidecar (40).

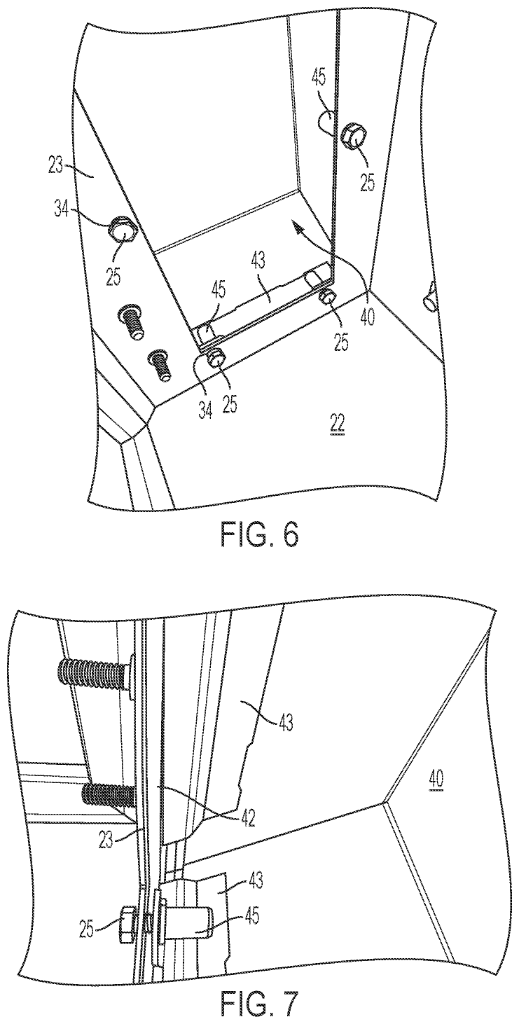

The sidecar (40) can be attached to the cabinet (22) using threaded fasteners (e.g., bolts) (25) inserted from the interior of the cabinet through the mounting apertures (34) and securely threaded into the internally threaded mounting bolts (45). This is best seen in the photographs of FIGS. 6 and 7, wherein FIG. 6 is a view from inside the cabinet (22) towards the interior of the sidecar (40), and FIG. 7 is a view from inside both the cabinet (on the left). As seen in FIG. 6, when the fasteners (25) are secured within the threaded mounting bolts (45), the seal (42) is compressed between the sidecar and the sidewall (23) of the cabinet, thereby preventing the ingress of liquids into the cabinet where the sidecar is attached to the cabinet. It will be understood that the sidecar can be sealingly secured to the cabinet using any of variety of fastener arrangement besides threaded bolts threadingly engaged within internally threaded mounting bolts. It should also be noted that the Interconnect bracket (80) (described below) is omitted in FIG. 6.

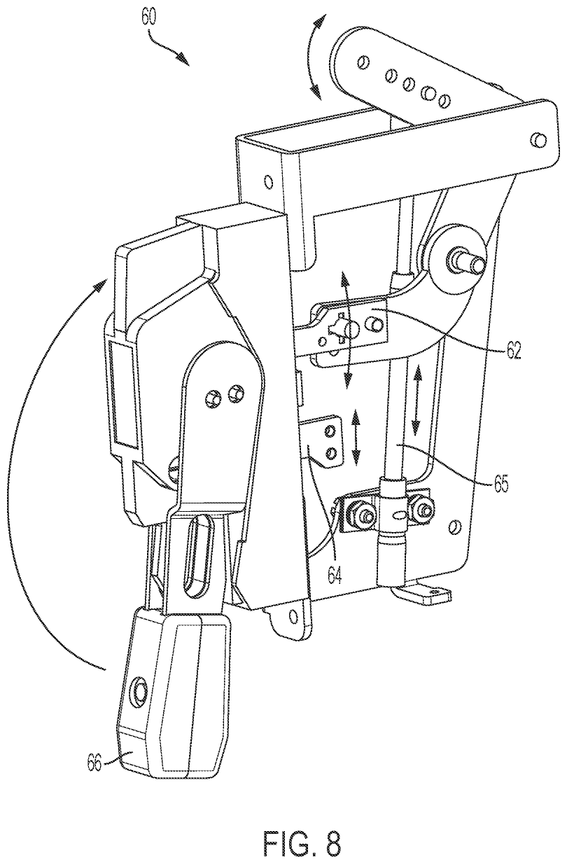

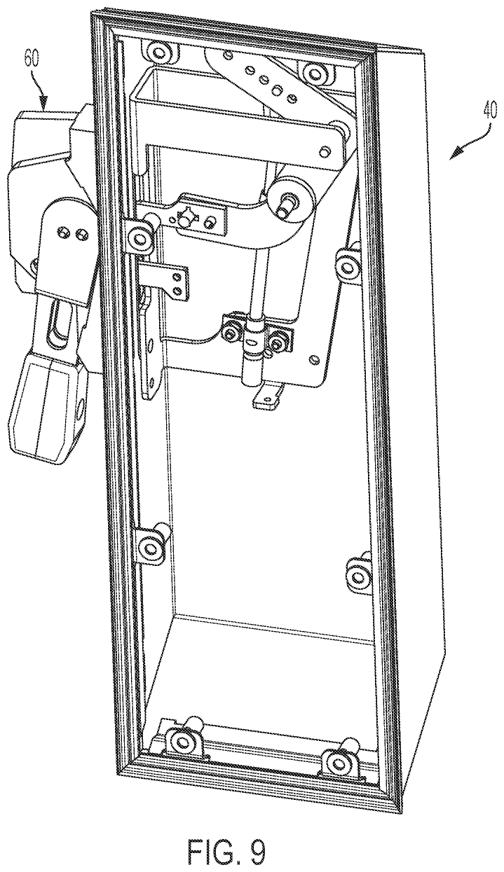

FIG. 8 depicts the FMD (60) that is operatively mounted to the front face (41) of the sidecar (40), and FIG. 9 depicts the FMD (60) mounted to the sidecar (40). A flexible shaft (not shown) connects to the bottom end of an actuator shaft (65) for tripping and resetting a circuit breaker (not shown) connected to the other end of the flexible shaft. The actuating lever (66) is in its lowermost position in FIG. 8 (the “off” position). When in this position, the circuit breaker in the cabinet will be tripped, preventing power from being delivered to the cabinet and allowing the cabinet to be safely accessed. An actuator link (62) and a door interlock link (64) are operatively connected to the actuating lever (66). When the actuating lever (66) is pivoted upward in the direction shown (to the “on” position), actuator link (62) will pivot downward causing the actuator shaft (65) to move in the downward direction. This downward movement of the actuator shaft (65) will reset the circuit breaker, allowing power to be delivered to the cabinet (22).

The door interlock link (64) is operable to prevent the actuating lever (66) from being pivoted upward to the on position, and also to prevent the access door (26) from being opened while the actuating lever is in the on position (i.e., when power is being delivered to the cabinet). Door interlock link (64) is spring-biased (or pre-loaded) in the upward direction, and is shown in its initial, locking position in FIG. 8 whereat the door interlock link (64) prevents the actuating lever (66) from being pivoted upward to the on position. In order to pivot the actuating lever (66) to the on position, the door interlock link (64) must be urged downwardly against the spring-bias (or pre-load). When the door interlock link (64) has been urged downwardly a sufficient distance, the actuating lever (66) is released and the lever can be pivoted upward to the on position. If the force urging the door interlock link (64) is released, the interlock link (64) will move fully upward (past its initial position in FIG. 8), under the force of the spring-biasing, When the actuating lever (66) is returned to its off position shown in FIG. 8, the door interlock link will be returned (reset) to its locking position of FIG. 8.

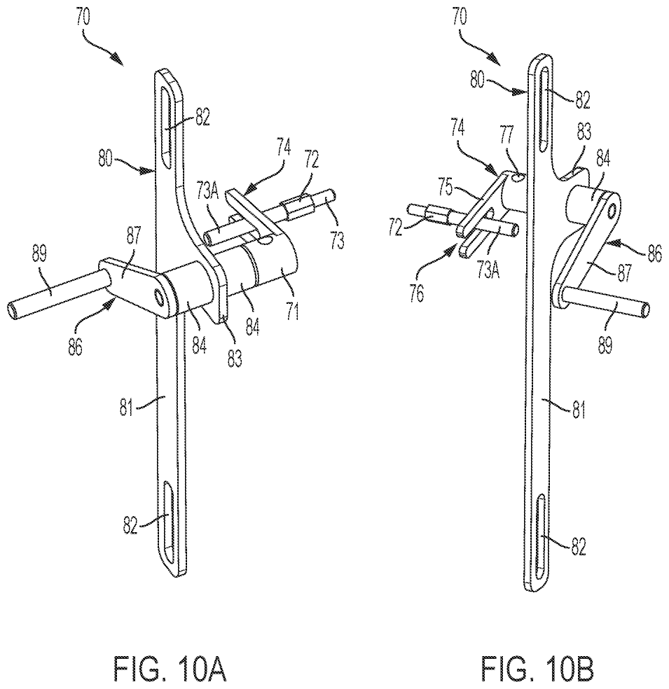

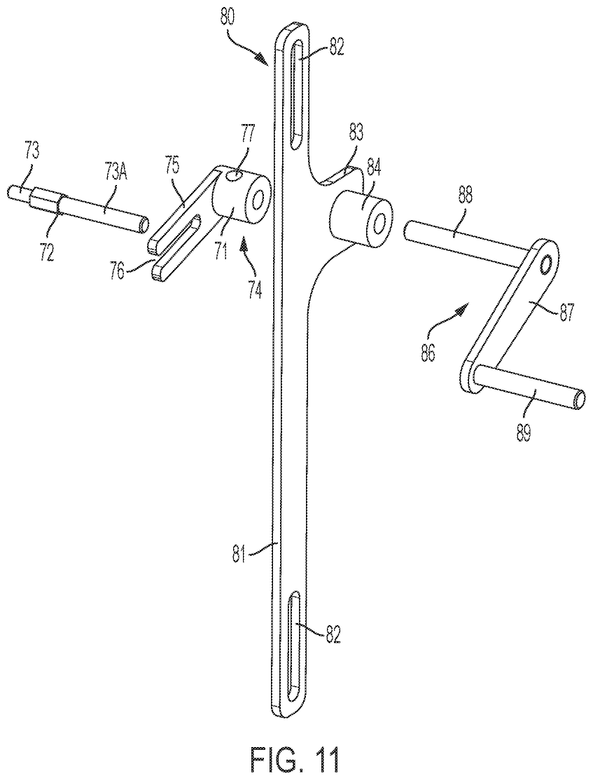

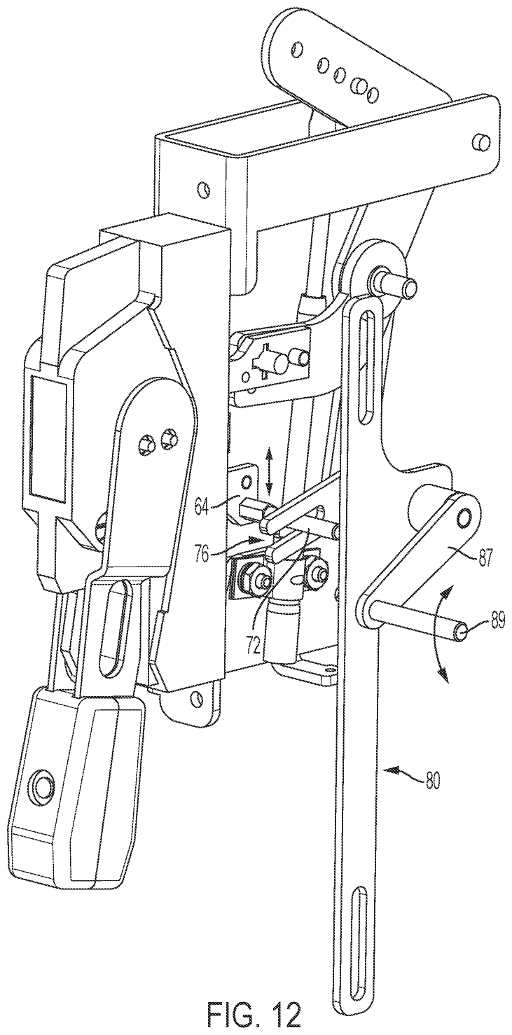

FIGS. 10A and 10B depict the interconnect assembly (70) of the present disclosure. FIG. 11 is an exploded view of the interconnect assembly (70). The interconnect assembly includes an interconnect pin (72), a slotted disconnect engagement lever (74), an interconnect bracket (80), and a door lock lever (86). The interconnect assembly (70) is used to operatively connect the door interlock link (64) to a door catch (90) mounted on the inside face of the access door (26), as further described below. As seen in FIG. 12, the interconnect pin (72) is connected to the door interlock link (64). In the particular embodiment shown, the distal end (73) of the pin (72) is inserted into an aperture in the door interlock link (64) and secure in place (e.g., using a threaded fastener). The elongate proximal shaft (73A) of the pin (72) is received within an elongate slot (76) of the slotted lever (74). In this manner, the interconnect pin (72) translates movement of the door interlock link (64) to the slotted lever (74).

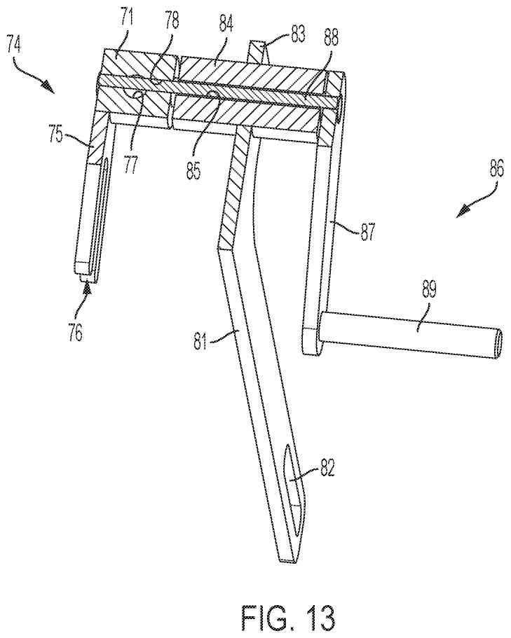

Slotted lever (74) includes an elongate lever arm (75) extending radially away from a distal end of an apertured barrel (71) having an internal aperture (78) (see cross-sectional view of FIG. 13). The slotted lever (74) is mounted for rotation about the axis of the barrel (71), with the interconnect pin (72) slidably movable within the elongate slot (76) provided in the lever arm (75). The elongate slot (76) extends radially away from the barrel (71) such that rotational movement of the barrel around its axis causes sliding, substantially linear movement (up and down) of the interconnect pin (72). An internally threaded bore (77) extends through the sidewall of the barrel (71) and intersects the internal aperture (77). The threaded bore (77) receives a threaded set pin (not shown) and is used to secure an elongate pivot pin (88) of the door lock lever (86) within, and rotationally fixed with respect to, the aperture (77) and barrel (71).

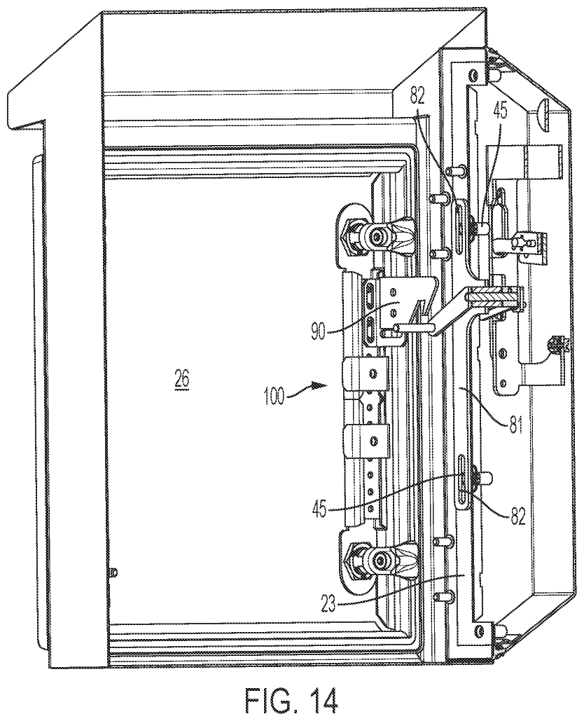

Interconnect bracket (80) includes an elongate mounting plate (81) having oval-shaped mounting apertures (82) at opposite ends thereof. As best seen in the cross-sectional view of FIG. 14, the mounting apertures (82) are used to alignably secure the interconnect bracket (80) within the cabinet against the interior face of the sidewall (23). In particular, with the oval-shaped mounting apertures (82) aligned with the internally threaded mounting bolts (45) of the sidecar assembly, the threaded fasteners (25) used to attach the sidecar to the cabinet are inserted from the interior of the cabinet through the oval-shaped mounting apertures (82) and threaded into the internally threaded mounting bolts (45). This secures the interconnect bracket (80) to the interior face of sidewall (23), as seen in FIG. 14. The elongate shape of the oval-shaped mounting apertures (82) allow for the mounting height of the interconnect bracket (80) to be adjusted as needed, particularly to ensure that the door catch pin (89) is at the proper height to engage door catch (90).

Interconnect bracket (80) further includes a rearwardly extending flange (83) adjacent and below the uppermost mounting aperture (82). As best seen in the cross-sectional view of FIG. 13, the flange (83) includes an aperture for receiving an elongate barrel (84) therethrough. The barrel (84) is secured within the aperture of the flange (83), and includes an aperture (85) configured to receive the elongate pivot pin (88) of the door lock lever (86) within. The aperture (85) is sized and configured such that the pivot pin (88) may freely rotate within the aperture (85). The pivot pin (88) is sufficient long so that it extends through the length of the barrel (84) into the internal aperture (78) of the barrel (71) of the slotted lever (74) (see cross-sectional view of FIG. 13).

The door lock lever (86) includes the elongate pivot pin (88) extending distally and orthogonally away from one end of a lever arm (87) and a door catch pin (89) proximally and orthogonally away from the opposite end of the lever arm (87). As noted above, the elongate pivot pin (88) extends through the length of the barrel (84) and into the internal aperture (78) of the barrel (71) of the slotted lever (74). Thus, when the distal end portion of the pivot pin (88) is secured within the barrel (71) (e.g., using a set screw), rotation of the slotted lever about the axis of the pivot pin (88) (caused by sliding, substantially linear movement of the interconnect pin (72) within the elongate slot (76)) results in corresponding rotation of the door catch pin (89).

As best seen in FIGS. 14-18, a door catch (90) is mounted to the interior face of the access door (26). The door catch (90) includes an angled catch slot (92) formed between a sloped forward wall, or ramp, (94) and downwardly extending rear wall (95). The catch slot (92) is this open at its lower end and closed at its upper end (93). The sloped ramp (94) extends upward to the upper end (93), forming the front wall of the catch slot (92). The door catch (90) is mounted to the access door in alignment with the door catch pin (89) by an adjustable mounting arrangement, further described below.

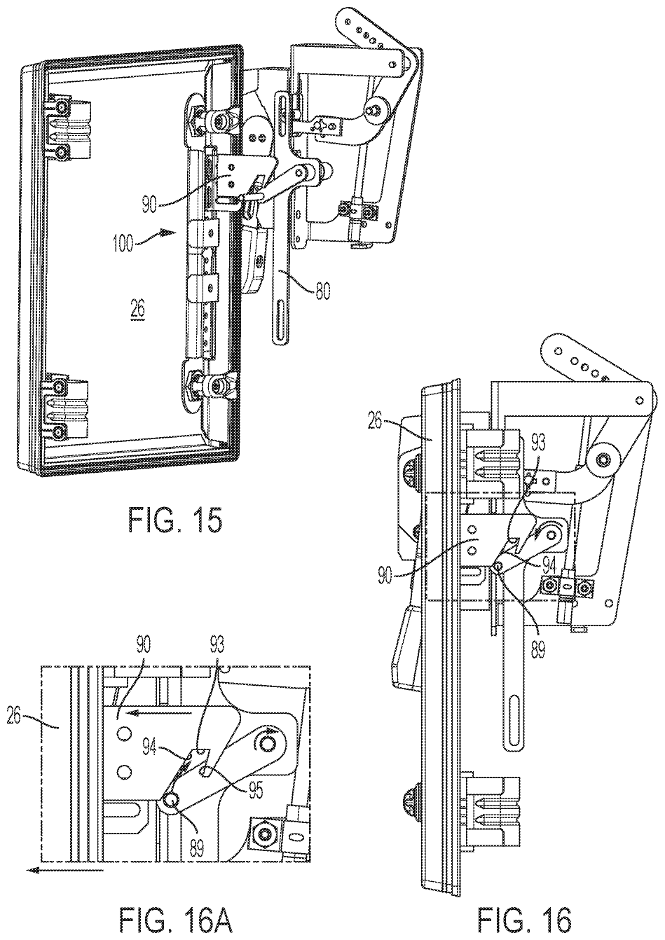

The door catch pin (89) is aligned with the catch slot (92) such that, as the access door (26) is closed, the catch pin (89) rides along ramp (94) until the door catch pin reaches the lower end portion of the ramp (FIGS. 15 and 16). This downward movement of the door catch pin (89) causes counterclockwise rotation of the door lock lever (86) (as viewed from the perspective of FIGS. 15 and 16, which in turn causes counterclockwise (downward) rotation of slotted lever (74). This rotation of the slotted lever (74) results in sliding, substantially linear movement (downward) of the interconnect pin (72), which urges the door interlock link (64) of the FMD (60) downwardly against the pre-load so as to release the actuating lever (66) of the FMD. The actuating lever of the FMD can then be pivoted upward to the on position, thereby closing the circuit breaker and supplying power to the enclosure.

If a user attempts to open the access door (26) while power is being supplied to the cabinet, the access door will pivot in the direction of the arrow at the bottom of the enlarged view of FIG. 16A. This will also cause the catch (90) to move in the same direction, away from the door catch pin (89). Since the door catch pin (89) is biased upwardly by the FMD (via the interconnect assembly of the present disclosure), the door catch pin will slide upwardly along the ramp (94) until it reaches the upper end (93) of the catch slot (92). The catch pin (89) will remain in this position due to biasing of the catch pin as long as the actuating lever (66) is in the on position. As the access door (26) is further urged open by the user, the catch pin (89) will abut against the rear wall (95) of the catch slot (92), thereby preventing the access door from being opened. While the access door (26) can be opened slightly, the interaction between the catch pin (89) and the catch (90) will prevent the access door from being opened no more than about 1 inch (or even less).

When the actuating lever (66) of the FMD is returned to its off position shown in FIG. 8, the door interlock link (64) will be returned (reset) to its locking position of FIG. 8. As a result, the catch pin (89) will be positioned at a level just below the lower end of rear wall (95) of the catch slot (92). This allows catch pin (89) to clear the rear wall (95) of the catch slot (92) such that the access door (26) can be fully opened.

The door catch (90) can be mounted to the inside face of the access door (26) in a variety of ways such as being bolted or welded to the inside face of the access door. Embodiments of the present disclosure provide an adjustable mounting assembly (100) that facilitates mounting of the door catch (90) to the access door, while providing adjustability so that the system can be used with a wide variety of existing cabinets and access doors.

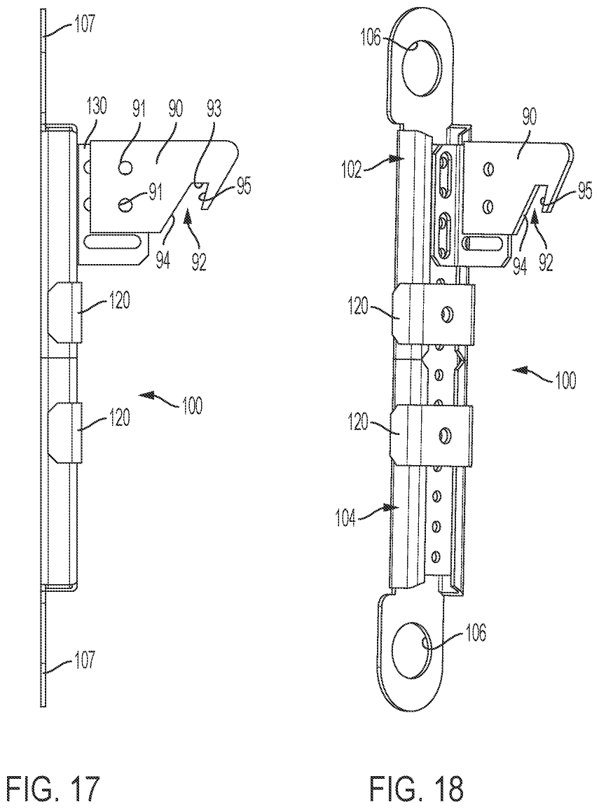

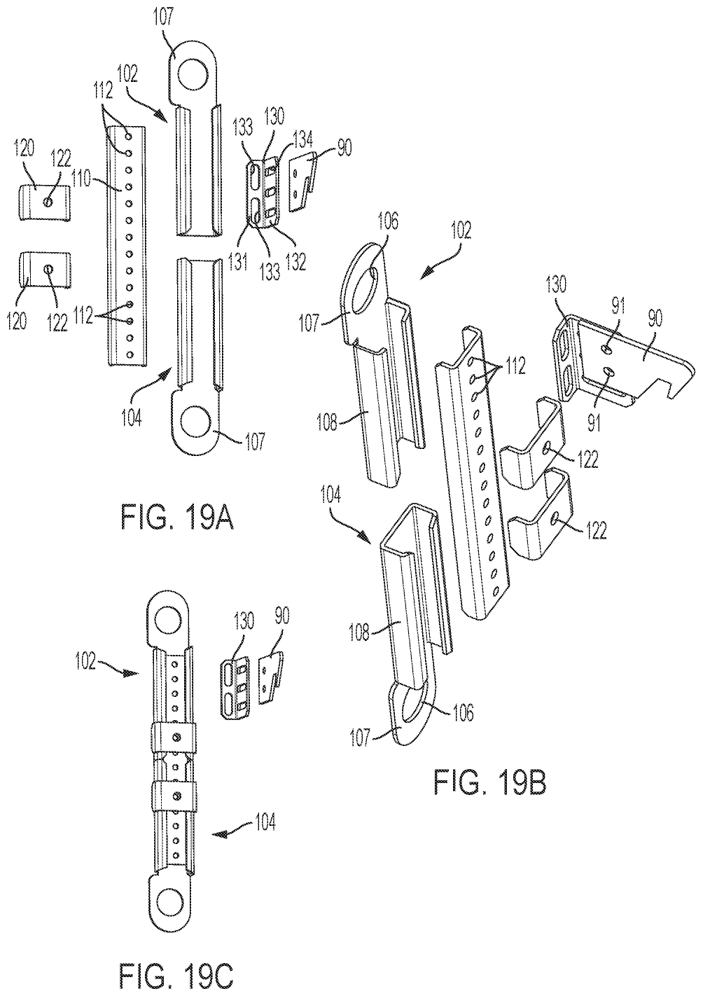

As seen in FIGS. 17-20, the adjustable mounting assembly is telescoping, and includes upper and lower channel members (102, 104), a slide plate (110) slidably received within the channel members, a pair of slide locks (120), and a door catch mounting bracket (130). Each channel member includes an aperture (106) extending through a flat tab (107) at one end and a channel section (108) extending linearly away from the aperture (106). The channel section is open along its outer face such that the channel section has a generally C-shaped cross-section, as best seen in FIG. 19C. The open outer face allows for the slide plate (110) to be accessible when the slide plate is positioned within the channel members. While a unitary channel member alternatively can be employed (i.e., combining channel members (102, 104) into a single structure), bifurcation of the channel member provides additional flexibility in the ability to use the adjustable mounting assembly with a variety of cabinets and access doors.

The slide plate (110) is sized and configure to be slidably received within the channel sections (108) of the upper and lower channel members (102, 104). The slide plate has a series of apertures (112) extending through its face, and has a U-shaped cross-section for added strength and rigidity. The apertures (112) can be threaded to receive a threaded fastener therein (e.g., a threaded bolt or screw). Each of the slide locks (120) has a generally U-shaped cross section and is configured to fit over the and around the sides of the channel sections (108) of the channel members (102, 104). Each slide lock also includes an aperture (122) in their respective faces.

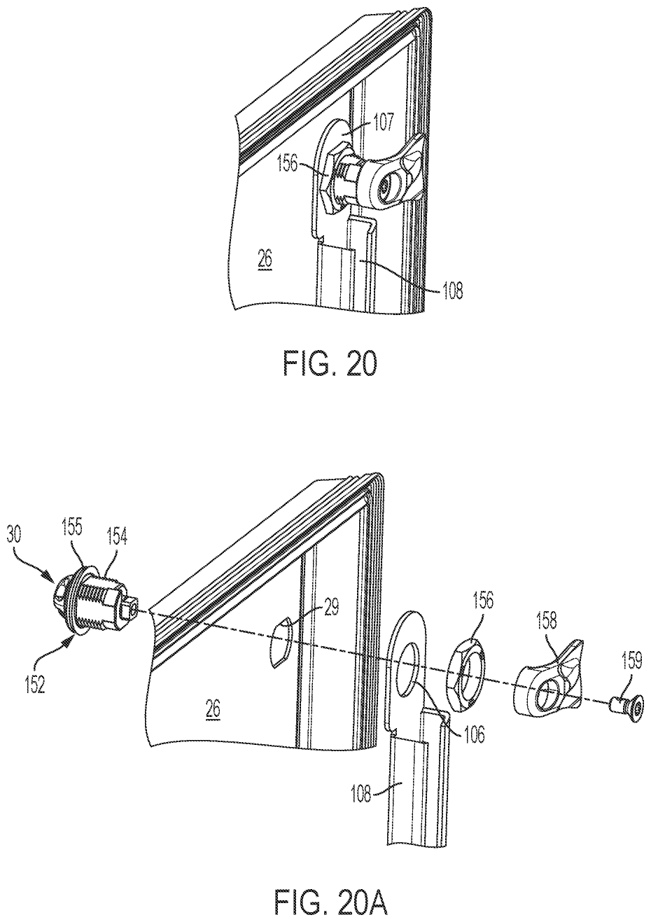

As best seen in FIGS. 20 and 20A, the apertures (106) in the upper and lower channel members (102, 104) are used to secure the channel members to the inside face of the access door (26). In particular, access door (26), as is typical of such structures, includes a pair of lock mounting apertures (29) configured to receive the body (152) of lock (30) therein. The lock body (152) includes a threaded portion (154) sized to the received through the access door aperture (29) and an enlarged flange (155) that does not fit through the door aperture. With the threaded portion (154) positioned within the aperture (29) and the flange sealingly abutted against the exterior face of the access door (26), a threaded nut (156) is used so secure the lock (30) to the access door. As seen in FIGS. 20 and 20A, the aperture (106) is also sized to receive the threaded portion (154) of the lock but is smaller than the outer diameter of the threaded nut (156). Thus, the threaded nut (156) can be used to secure the channel member to the interior face of the access door, with the threaded portion (154) of the lock extending through the aperture (106) in the tab (107) of the channel member. The lock further includes a lock plate (158) secured to the lock body by a screw (159).

The slide plate (110) is inserted into the channel sections (108) of the upper and lower channel members (102, 104), with the channel members secured to the interior face of the access door as described above. The slide plate (110) is adjusted to the proper height within the channel members and is secured in place by the slide locks. Specifically, the slide lock are slid over the channel members (102, 104) and a threaded fastener is inserted into each aperture (122) in a slide lock (120) and threadably secured within a threaded aperture (112) of the slide plate (110).

Mounting bracket (130) is used to secure the door catch (90) to the slide plate (110). As best seen in FIG. 19A, the mounting bracket is a right angle bracket having a first plate (131) and a second plate (132) extending orthogonal to the first plate. Each plate (131, 132) include a plurality of elongated apertures (133, 134). the Elongated apertures (133) in the first plate are used to secure the mounting bracket (130) to the slide plate (110) using threaded fasteners inserted through the apertures (133) that are then secured within a threaded aperture (112) of the slide plate (110). Similarly, threaded fasteners can be used to secure the second plate (132) to the door catch (90) using a pair of apertures (91) provided in the door catch. The elongated apertures (133, 134) provide additional adjustability in the positioning of the door catch (90).

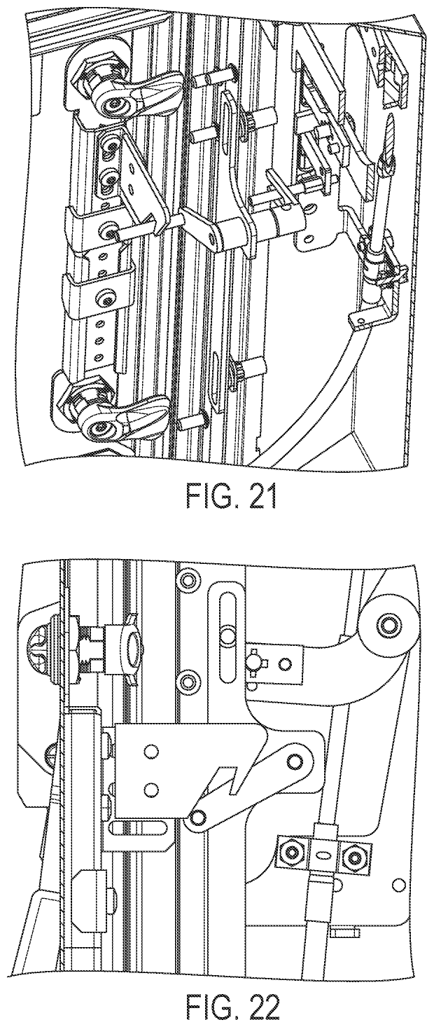

FIGS. 21 and 22 depict additional enlarged views of a portion of an assembled electrical enclosure, access door, attached sidecar, FMD, interconnect assembly and adjustable mounting assembly of the present disclosure, wherein a portion of the FMD is shown in cross-section and other components typically found within the enclosure have been omitted. FIGS. 21 and 22 particularly include the various fasteners for assembling the structures described herein.

While various embodiments of a door lock interconnect system and related structures have been described in detail above, it will be understood that the components, features, and configurations, as well as the method of manufacturing and assembling the devices described herein are not limited to the specific embodiments described herein.

1. A door lock interconnect system for interfacing with a disconnect for an electrical enclosure, the disconnect having an operating lever having a door interlock link operatively connected to the operating lever, the operating lever pivotable between on and off positions and operative to control circuit breakers supplying power to the electrical enclosure, and the electrical enclosure having a cabinet and an access door, the door lock interconnect system comprising:
(a) an interconnect assembly having
a door lock lever adapted for pivotal movement about an axis, and
a disconnect engagement lever adapted for pivotal movement about said axis, the disconnect engagement lever further adapted to engage with the door interlock link of the disconnect such that movement of the door interlock link causes pivotal movement of the disconnect engagement lever
wherein the door lock lever and the disconnect engagement lever are operatively connected such that the pivoting of one of the door lock lever and the disconnect engagement lever about said axis results in pivoting of the other of the door lock lever and the disconnect engagement lever about said axis;
(b) a door catch engageable by the door lock lever of the interconnect assembly; and
(c) an adjustable mounting assembly, the door catch attachable thereto, the adjustable mounting assembly adapted to be secured to an interior face of the access door, with the door catch attached to the adjustable mounting assembly, wherein the door catch and the adjustable mounting assembly are adapted to adjustably locate the door catch with respect to the interior face of the access door;
wherein the interconnect assembly is configured to be operatively mounted to the electrical enclosure between the disconnect and the access door such that the interconnect assembly operatively links the door interlock link of the disconnect and the door catch whereby the operating lever cannot be pivoted to its on position if the access door is open, and the access door cannot be opened if the operating lever is at its on position.

2. The door lock interconnect system of claim 1, wherein the door lock lever further comprises a door lock catch pin, and the door catch further comprises a door catch slot for slidably receiving the door lock catch pin of the door lock lever.

3. The door lock interconnect system of claim 2, wherein the interconnect assembly further comprises a rotational member located on said axis, the rotational member extending between and operatively connecting the door lock lever and the disconnect engagement lever such that pivoting of the disconnect engagement lever about said axis causes pivoting of the door lock lever about the axis of the rotational member.

4. The door lock interconnect system of claim 3, wherein the interconnect assembly further comprises an interconnect pin and the disconnect engagement lever includes a slot for slidably receiving the interconnect pin, the interconnect pin adapted to be connected to the door interlock link of the disconnect.

5. The door lock interconnect system of claim 4, wherein the interconnect pin is adapted to be connected to the door interlock link of the disconnect such that substantially linear movement of the door interlock link will be translated into pivotal movement of the disconnect engagement lever.

6. The door lock interconnect system of claim 5, wherein the engagement lever further comprises an elongate lever arm, wherein the slot in the engagement lever extends from a distal open end of the lever arm along at least a portion of a length of the elongate lever arm.

7-8. (canceled)

9. The door lock interconnect system of claim 3, wherein the interconnect assembly further comprises an interconnect bracket adapted for attachment to the electrical enclosure, and further wherein the interconnect bracket comprises a mounting plate, and further wherein the door lock lever of the interconnect assembly is adjacent a first side of the mounting plate and the disconnect engagement lever is located adjacent a second side of the mounting plate such that the mounting plate is located between the door lock lever and the disconnect engagement lever.

10. The door lock interconnect system of claim 9, wherein the interconnect assembly further comprises a fixed member extending laterally away from at least one of the first and second sides of the mounting plate, the fixed member having an aperture extending thererethrough, wherein the rotational member is rotatably positioned within the fixed member.

11. The door lock interconnect system of claim 10, wherein the rotational member comprises a pivot pin having first and second ends, and the door lock lever and the disconnect engagement lever are secured to opposite ends of the pivot pin.

12. The door lock interconnect system of claim 3, wherein the interconnect bracket is adapted to be secured to the electrical enclosure adjacent to an opening in a sidewall of the electrical enclosure such that the door lock lever is located within the electrical enclosure and the engagement lever is located external to the electrical enclosure adjacent the sidewall opening.

13-14. (canceled)

15. The door lock interconnect system of claim 2, wherein the door catch slot extends between an open lower end, a sloped forward wall extending upwardly from the open lower end to a closed upper end of the slot, and a rear wall extending downwardly from the closed upper end and spaced away from the sloped forward wall, and further wherein the door catch and adjustable mounting assembly are securable to the interior face of the access door such that the door catch slot extends at an angle with respect to the interior face of the access door.

16. The door lock interconnect system of claim 1, wherein the adjustable mounting assembly comprises:
a first fixation member adapted to be secured to the interior face of the access door,
a slide plate adapted to be adjustably secured to the first fixation member and to be secured to the door catch, such that the position of the door catch with respect to the access door is adjustable by adjustment of the securement of the slide plate to the fixation member.

17. The door lock interconnect system of claim 16, wherein the first fixation member of the adjustable mounting assembly comprises a first channel member, wherein the slide plate is slidingly received within the first channel member for adjustably securing the slide plate to the channel member.

18. The door lock interconnect system of claim 17, wherein the door catch is adjustably securable to the slide plate.

19. The door lock interconnect system of claim 16, wherein the adjustable mounting assembly further comprises at least one slide lock for securing the slide plate within the first channel member.

20. The door lock interconnect system of claim 16, wherein the adjustable mounting assembly further comprises a second channel member adapted to be secured to the interior face of the access door in vertical alignment with the first channel member, wherein the slide plate is slidingly received within both the first and second channel members.

21. The door lock interconnect system of claim 20, wherein the adjustable mounting assembly comprises of a pair of slide locks, each slide lock configured to secure the slide plate in one of said channel members.

22. The door lock interconnect system of claim 16, wherein the adjustable mounting assembly further comprises a door catch mounting bracket for securing the door catch to the slide plate.

23. The door lock interconnect system of claim 22, wherein the door catch is adjustably secured to the door catch mounting bracket, and the door catch mounting bracket is adjustably securable to the slide plate.

24. The door lock interconnect system of claim 1, wherein the adjustable mounting assembly is telescopically adjustable in length such that the position of the door catch with respect to the access door is adjustable by telescoping adjustment of the adjustable mounting assembly.

25-27.

28. A disconnect module for attachment to an electrical enclosure having a cabinet and an access door, the disconnect module comprising:
(a) an adapter box adapted to be attached to a sidewall of the electrical enclosure adjacent the access door;
(b) a flange mount disconnect (FMD) mounted to the adapter box, the FMD having an operating lever and a door interlock link operatively connected to the operating lever, the operating lever pivotable between on and off positions and operative to control circuit breakers supplying power to the electrical enclosure;
(c) an interconnect assembly including
a pivotally mounted door lock lever having a door lock catch pin, and
a pivotally mounted disconnect engagement lever adapted to engage with the door interlock link of the FMD such that pivotal movement of the door interlock link causes pivotal movement of the disconnect engagement lever
wherein the door lock lever and the disconnect engagement lever are operatively connected such that pivoting of the engagement lever results in pivoting of the door lock lever;
(d) a door catch having a slot for slidably receiving the door lock catch pin of the interconnect assembly; and
(e) an adjustable mounting assembly, the door catch attachable thereto, the adjustable mounting assembly adapted to be secured to an interior face of the access door, with the door catch attached to the adjustable mounting assembly, wherein the door catch and the adjustable mounting assembly are adapted to adjustably locate the door catch with respect to the interior face of the access door;
wherein the interconnect assembly is configured to be operatively mounted to the electrical enclosure between the disconnect and the access door such that the interconnect assembly operatively links the door interlock link of the FMD and the door catch whereby the operating lever cannot be pivoted to its on position if the access door is open, and the access door cannot be opened if the operating lever is at its on position.
